(19) United States
(12) Patent Application Publication
(10) Pub. No.: US 2015/0291389 A1
(43) Pub. Date: Oct. 15, 2015

(54) ELEVATOR DISPLAY CONTROL DEVICE

(71) Applicant: KAZUHIRO ONO, Tokyo (JP)

(72) Inventor: Kazuhiro Ono, Tokyo (JP)

(73) Assignee: MITSUBISHI ELECTRIC CORPORATION, Chiyoda-ku, Tokyo (JP)

(21) Appl. No.: 14/441,887

(22) PCT Filed: Dec. 17, 2012
(86) PCT No.: PCT/JP2012/082617

§ 371 Date: May 11, 2015

(51) Int. Cl. B66B 3/00; B66B 3/02

(52) U.S. Cl. CPC B66B 3/006; B66B 3/02

(57) ABSTRACT

Provided is an elevator display control device capable of informing users whether or not an elevator car which has arrived at a hall will arrive at a destination floor. The elevator display control device is provided with an analysis part analyzing service floors of a plurality of cars arranged in one shaft, and a display control part causing a display part provided in a hall to display, on a basis of analysis results of the analysis part, information indicating the order of cars arriving at the hall in question by correlating the information with information indicating service floors of cars arriving in the order in question. This configuration makes it possible to guide users to an optimum car.

### TECHNICAL FIELD

The present invention relates to an elevator display control device.

### BACKGROUND ART

There have been proposed elevator display control devices which cause a display device of a hall to display positions, operation directions and operation conditions of a plurality cars, whether or not boarding is permitted, and the like. According to the elevator display control devices, users can recognize the operation condition of a car which has arrived at a hall (refer to Patent Literature 1, for example).

### CITATION LIST

### Patent Literature

### Patent Literature 1: Japanese Patent Laid-Open No. 2002-60153

### Patent Literature 2: Japanese Patent Laid-Open No. 9-77435

### Patent Literature 3: Japanese Patent Publication No. 60-37032

### Patent Literature 4: Japanese Utility Model Laid-Open No. 7-30262

### Patent Literature 5: Japanese Patent Laid-Open No. 5-155538

### Patent Literature 6: Japanese Patent Laid-Open No. 7-277623

### Patent Literature 7: Japanese Utility Model Laid-Open No. 2011-121719

### SUMMARY OF INVENTION

### Technical Problem

However, in the elevator display control device described in Patent Literature 1, users cannot recognize whether or not a car which has arrived at a hall will arrive at a destination floor.

The present invention was made in order to solve the above-described problem and the object thereof is to provide an elevator display control device capable of informing users whether or not an elevator car which has arrived at a hall will arrive at a destination floor.

### Means for Solving the Problems

An elevator display control device of the present invention includes an analysis part analyzing service floors of a plurality of cars arranged in one shaft, and a display control part causing a display part provided in a hall to display, on a basis of analysis results of the analysis part, information indicating the order of cars arriving at the hall by correlating the information with information indicating service floors of cars arriving in the order in question.

### Advantageous Effect of Invention

According to the present invention, it is possible to inform users whether or not an elevator car which has arrived at a hall will arrive at a destination floor.

### BRIEF DESCRIPTION OF THE DRAWINGS

FIG. 1 is a general block diagram of an elevator in which an elevator display control device in Embodiment 1 of the present invention is used.

FIG. 2 is a diagram to explain a user information table of an elevator in which the elevator display control device in Embodiment 1 of the present invention is used.

FIG. 3 is a diagram to explain a use history table of elevators in which the elevator display control device in Embodiment 1 of the present invention is used.

FIG. 4 is a front view of the display part provided in the hall operating panel of elevators in which the elevator display control device in Embodiment 1 of the present invention is used.

FIG. 5 is a flowchart to explain the actions of the elevator display control device in Embodiment 1 of the present invention.

FIG. 6 is a block diagram of elevators in which an elevator display control device in Embodiment 2 of the present invention is used.

FIG. 7 is a front view of the display part provided in the hall operating panel of elevators in which the elevator display control device in Embodiment 2 of the present invention is used.

### DESCRIPTION OF EMBODIMENTS

Embodiments of the present invention will be described in accordance with the accompanying drawings. In each of the drawings, identical numerals refer to identical or corresponding parts and overlaps of description of these parts are appropriately simplified or omitted.

### Embodiment 1

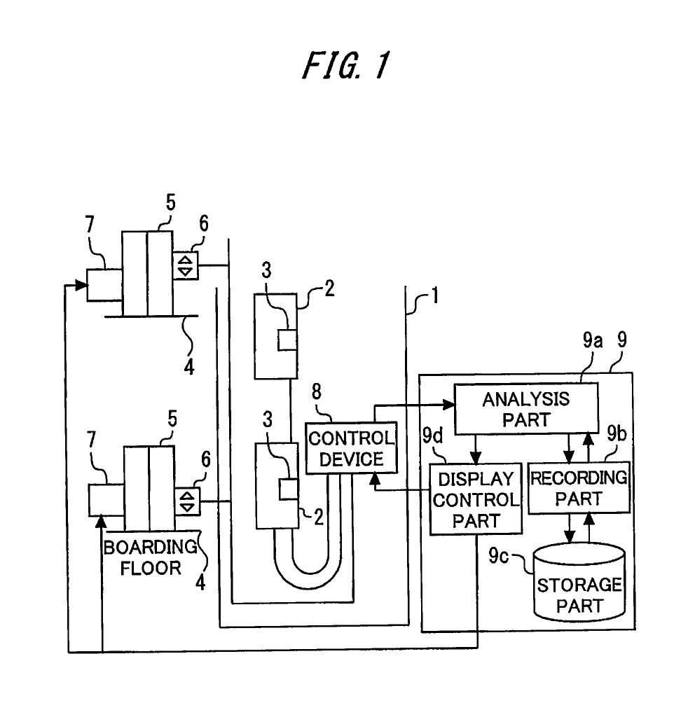

FIG. 1 is a general block diagram of an elevator in which an elevator display control device in Embodiment 1 of the present invention is used.

In a one-shaft multicar elevator of FIG. 1, a shaft 1 is formed in such a manner as to pierce through each floor of a building. A buffer (not shown) is provided at the bottom of the shaft 1. Guide rails (not shown) are provided in the shaft 1. A traction machine (not shown) is provided in the shaft 1 or a machine room (not shown). A main rope (not shown) is wound on a sheave (not shown) of the traction machine.

A counterweight (not shown) is suspended on one side of the main rope. Two car apparatuses 2 are suspended on the other side of the main rope. The two car apparatuses 2 are arranged in such a manner as to coincide with each other on a vertical projection plane. Each of the two car apparatuses 2 is held by guide rails. Each of the car apparatuses 2 consists of a cab, a car door, a door device, a car operating panel 3 and the like.

A governor (not shown) is provided in the shaft 1. A governor rope (not shown) is wound on the governor. The governor rope is coupled to the car apparatuses 2.

A hall 4 is provided on each floor of the building. The hall 4 is provided with a hall door 5. A hall button 6 is provided on one side of the hall door 5. A hall operating panel 7 is provided on the other side of the hall door 5. A gate (not shown) is provided at the entrance to the hall 4. The gate is provided with a card reader (not shown).

A control device 8 is provided in the shaft 1 or the machine room. The control device 8 is connected to the door device, the car operating panel 3, the hall buttons 6, the hall operating panels 7 and the like. A display control device 9 is connected to the control device 8.

The display control device 9 is provided with an analysis part 9a, a recording part 9b, a storage part 9c; and a display control part 9d. The analysis part 9a is connected to the control device 8. The recording part 9b is connected to the analysis part 9a. The storage part 9c is connected to the recording part 9b. The display control part 9d is connected to the analysis part 9a, the control device 8, and the hall operating panels 7.

Users of the elevator in question carry a card. A personal number is recorded in the card. The personal number identifies a user uniquely. The user passes the entrance to the hall 4. On this occasion, the user holds the card to the card reader.

The card reader reads the personal number from the card. The card reader sends information corresponding to the personal number in question to the control device 8. The control device 8 receives the information corresponding to the personal number in question. On this occasion, the control device 8 recognizes the present date and hour as the date and hour of use of the elevator. The control device 8 sends information corresponding to the personal number in question and the date and hour of use in question to the display control device 9.

After that, the user moves to the hall 4. After that, the user registers a service floor from the hall operating panel 7.

The hall operating panel 7 sends information corresponding to the service floor in question to the control device 8. The control device 8 controls the whole elevator. For example, the control device 8 recognizes the floor for which the service floor in question has been inputted as a floor to be used. The control device 8 assigns the hall call to the floor to be used in question and the car call to the service floor in question to one of the two car apparatuses 2. The control device 8 sends information corresponding to the floor to be used in question and the service floor in question to the display control device 9.

In the display control device 9, the analysis part 9a sends information corresponding to the personal number in question, the date and hour of use in question, the floor to be used in question, and the service floor in question as user information to the recording part 9b. The recording part 9b records the user information in question as a user information table in the memory and the like of the storage part 9c.

On this occasion, the analysis part 9a grasps the frequency of use of the elevator by the user corresponding to the personal number in question. The analysis part 9a sends information which is obtained by giving serial numbers to the user information in question and the frequency of use in question as a use history to the recording part 9b. The recording part 9b records the use history in question as a use history table in the memory and the like of the storage part 9c.

On the basis of operation information from the control device 8, the analysis part 9a analyzes the number of the car apparatus 2 arriving at the floor to be used in question and the service floor of each car apparatus 2. On the basis of analysis results of the analysis part 9a, the display control part 9d causes the display part of the hall operating panel 7 of the floor to be used in question to display information indicating the order of arrival of the car apparatuses 2 by correlating the information with information indicating a service floor of each car apparatus 2.

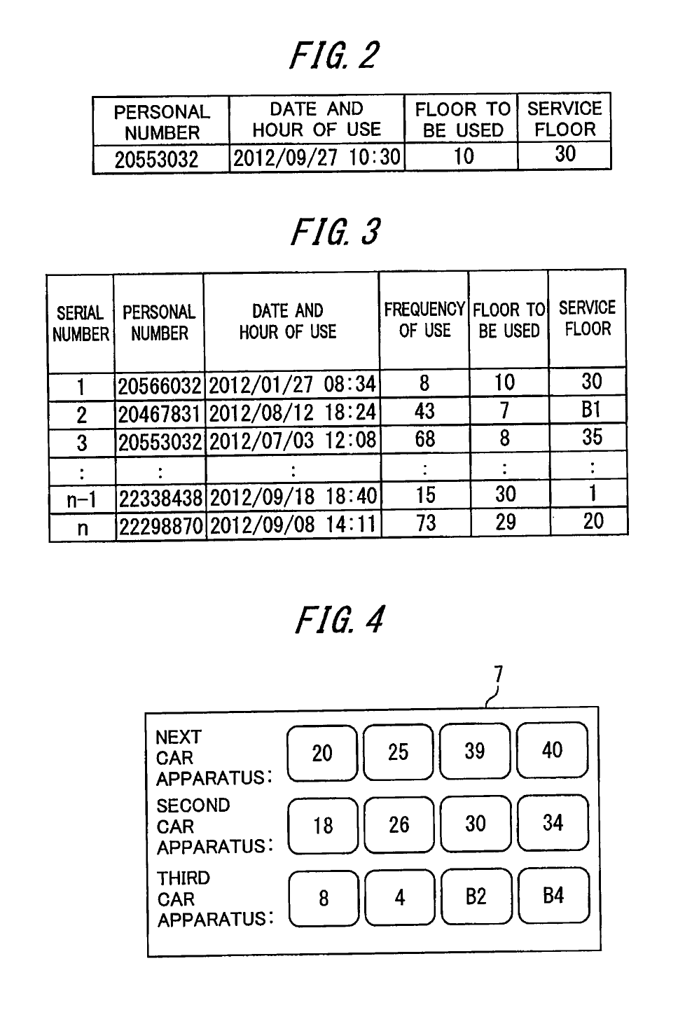

Next, a user information recording table will be described with the aid of FIG. 2.

FIG. 2 is a diagram to explain a user information table of an elevator in which the elevator display control device in Embodiment 1 of the present invention is used.

As shown in FIG. 2, in the user information recording table, a personal number, date and hour of use, a floor to be used, and a service floor are correlated with each other.

In FIG. 2, the personal number is expressed by an eight-digit numeral. The date and hour of use is expressed by date and time by minutes. The floor to be used is expressed by a numeral corresponding to a relevant floor. The service floor is expressed by a numeral corresponding to a relevant floor.

Next, a use history table will be described with the aid of FIG. 3.

FIG. 3 is a diagram to explain a use history table of elevators in which the elevator display control device in Embodiment 1 of the present invention is used.

As shown in FIG. 3, in the use history table, a serial number, a personal number, date and hour of use, frequency of use, a floor to be used, and a service floor are correlated with each other.

A personal number, frequency of use, a floor to be used, and a service floor are the same as in FIG. 2. Serial numbers are expressed by sequential numbers with the head as 1. Frequency of use is expressed by the total number of times of past use of an elevator by a user corresponding to the personal number in question.

Next, the display part of the hall operating panel 7 will be described with the aid of FIG. 4.

FIG. 4 is a front view of the display part provided in the hall operating panel 7 of elevators in which the elevator display control device in Embodiment 1 of the present invention is used.

As shown in FIG. 4, information indicating the order of arrival of the car apparatuses 2 is displayed on the left side of the display part. Specifically, “NEXT CAR APPARATUS” is displayed in the top portion of the figure. “NEXT CAR APPARATUS” means a car apparatus 2 arriving at a floor to be used first. “SECOND CAR APPARATUS” is displayed in the middle portion. “SECOND CAR APPARATUS” means the second car apparatus 2 arriving at a floor to be used. “THIRD CAR APPARATUS” is displayed in the bottom portion. “THIRD CAR APPARATUS” means the third car apparatus 2 arriving at a floor to be used.

A plurality of numerals are indicated on the right side of “NEXT CAR APPARATUS.” The plurality of numerals in question are numerals corresponding to the service floors of the car apparatus 2 arriving at a floor to be used first. A plurality of numerals are indicated on the right side of “SECOND CAR APPARATUS.” The plurality of numerals in question are numerals corresponding to the service floors of the second car apparatus 2 arriving at a floor to be used. A plurality of numerals are indicated on the right side of “THIRD CAR APPARATUS.” The plurality of numerals in question are numerals corresponding to the service floors of the third car apparatus 2 arriving at a floor to be used.

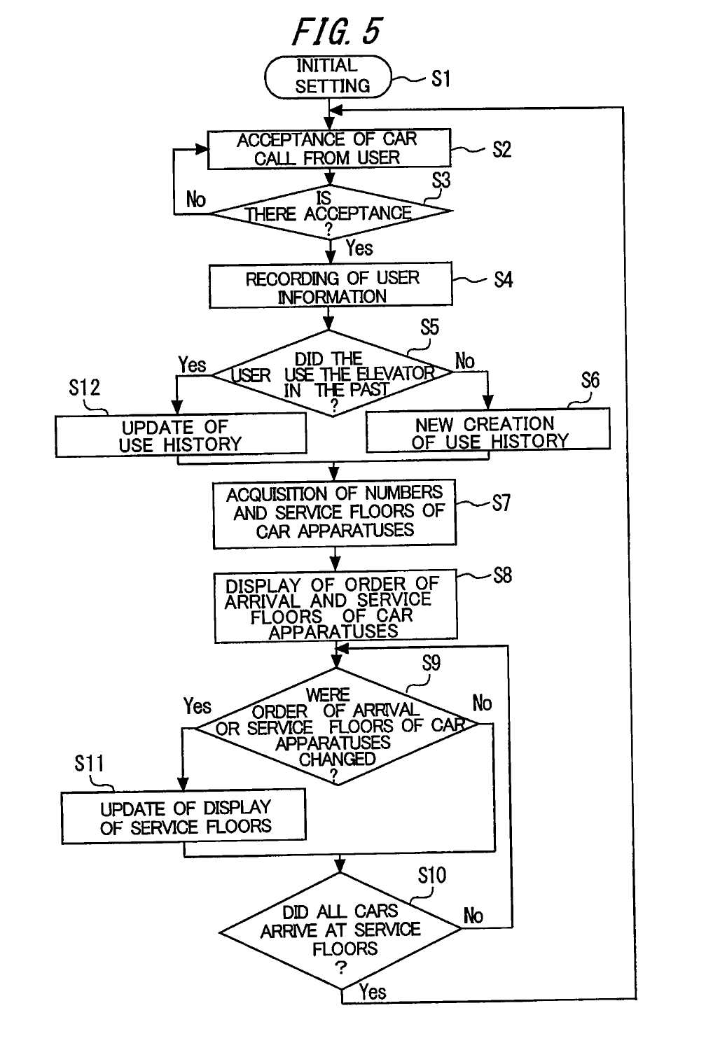

Next, the actions of the display control device 9 will be described with the aid of FIG. 5.

FIG. 5 is a flowchart to explain the actions of the elevator display control device 9 in Embodiment 1 of the present invention.

First, in Step S1, the analysis part 9a performs initial setting. Specifically, the analysis part 9a initializes a user information recording table and a use history table which are stored in the storage part 9c. After that, the flow of actions proceeds to Step S2, and the analysis part 9a starts the acceptance of a car call from a user. After that, the flow of actions proceeds to Step S3, and the analysis part 9a determines whether or not there is acceptance of a car call from a user on the basis of information from the control device 8.

In the case where there is no acceptance of a car call from a user in Step S3, the flow of actions returns to Step S2. In the case where there is acceptance of a car call from a user in Step S3, the flow of actions proceeds to Step S4. In Step S4, the analysis part 9a causes the recording part 9b to record a user information recording table corresponding to the user in question in the storage part 9c.

After that, the flow of actions proceeds to Step S5, and the analysis part 9a determines whether or not the user used the elevator in the past. Specifically, the analysis part 9a determines whether or not in the use history table of the storage part 9c, there is a row having the same personal information as in the user information recording table.

In the case where in Step S5 the user did not use the elevator in the past, the flow of actions proceeds to Step S6. In Step S6, the analysis part 9a adds a new row to the use history table of the storage part 9c. After that, the analysis part 9a records a value obtained by adding “1” to the serial number of the immediately preceding last row in the field of serial number of the new row. After that, the analysis part 9a records “1” in the field of frequency of use of the new row. After that, the analysis part 9a transcribes the personal number, date and hour of use, floor to be used, and service floor of the user information recording table in the personal number, date and hour of use, floor to be used, and service floor of the new row.

After that, the flow of actions proceeds to Step S7, and the analysis part 9a acquires operation information from the control device 8. Specifically, the analysis part 9a acquires information corresponding to the numbers of the car apparatuses 2 arriving at floors to be used and service floors of each car apparatus 2. On this occasion, the analysis part 9a grasps also the order of arrival of the car apparatuses 2. After that, the flow of actions proceeds to Step S8, and the display control part 9d causes the display part of the hall operating panel 7 to display information indicating the order of arrival of the car apparatuses 2 by correlating the information with information indicating services floors of each car apparatus 2 on the basis of information from the analysis part 9a.

After that, the flow of actions proceeds to Step S9 and the analysis part 9a periodically acquires operation information from the control device 8. On the basis of the operation information in question, the analysis part 9a grasps the numbers of the car apparatuses 2 arriving at floors to be used, service floors of each car apparatus 2, and the order of arrival of each car apparatus 2. On this occasion, the analysis part 9a determines whether or not the order of arrival of each car apparatus 2 or the service floors of each car apparatus 2 were changed.

In the case where in Step S9 the order of arrival of the car apparatuses 2 or the service floors of each car apparatus 2 were not changed, the flow of actions proceeds to Step S10. In Step S10, the analysis part 9a determines whether or not all of the car apparatuses 2 that arrived at floors to be used have arrived at the service floors of users.

In the case where in Step S10 all of the car apparatuses 2 that arrived at floors to be used have not arrived at the service floors of users, the flow of actions returns to Step S9.

In the case where in Step S9 the order of arrival of the car apparatuses 2 or the service floors of each car apparatus 2 were changed, the flow of actions proceeds to Step S11. In Step S11, the analysis part 9a sends acquired operation information to the hall operating panels 7 of floors to be used. On the basis of the operation information in question, the hall operating panels 7 of floors to be used update the display of service floors.

In the case where in Step S10 all of the car apparatuses 2 that arrived at floors to be used have arrived at the service floors of users, the actions from Step S1 on are repeated.

In the case where in Step S5 the user used the elevator in the past, the flow of actions proceeds to Step S12. In Step S12, the analysis part 9a adds “1” to the frequency of use. The analysis part 9a transcribes the personal number, date and hour of use, floor to be used, and service floor from the user information recording table. After that, the actions from Step S7 on are repeated.

According to Embodiment 1 described above, the display part of the hall operating panel 7 performs display by correlating information indicating service floors of the car apparatuses 2 arriving in the order of arrival of the car apparatuses 2 with information indicating the order of arrival of the car apparatuses 2 in question. For this reason, it is possible to inform a user whether or not the car apparatus 2 which arrived at the hall 4 will arrive at the destination floor of the user. That is, even in the case where a plurality of car apparatuses 2 stop at the same floor, it is possible to guide a user to a car apparatus 2 which is best suited to the movement of the user. As a result, it is possible to prevent a user from boarding a wrong car apparatus 2 or forgetting boarding a car apparatus 2.

The display part of the hall operating panel 7 displays information indicating the order of arrival of the car apparatuses 2 and service floors on the occasion when a service floor has been registered from the hall operating panel 7. That is, the information in question is not displayed until a service floor is registered from the hall operating panel 7. For this reason, it is possible to bring a user's attention to the information in question. On this occasion, when a car apparatus 2 which is to go to the user's service floor has arrived at a floor to be used, information may be provided by voice to make the user board the car apparatus 2 in question. The voice in question may be outputted from a speaker and the like provided in the hall operating panel 7.

It is also possible to adopt a configuration in which on the occasion when a hall call has been registered by pushing the hall button 6, the display part of the hall operating panel 7 is caused to display information indicating the order of arrival of the car apparatuses 2 and service floors. In this case, the information in question is not displayed until the hall button 6 is pressed. For this reason, it is possible to bring a user's attention to the information in question.

Furthermore, a personal number may be inputted from the hall operating panel 7. Also in this case, the display part of the hall operating panel 7 performs display by correlating information indicating service floors of each car apparatus 2 with information indicating the order of arrival of the car apparatuses 2. For this reason, it is possible to inform a user whether or not the car apparatus 2 which has arrived at the hall 4 will arrive at the destination floor of the user.

### Embodiment 2

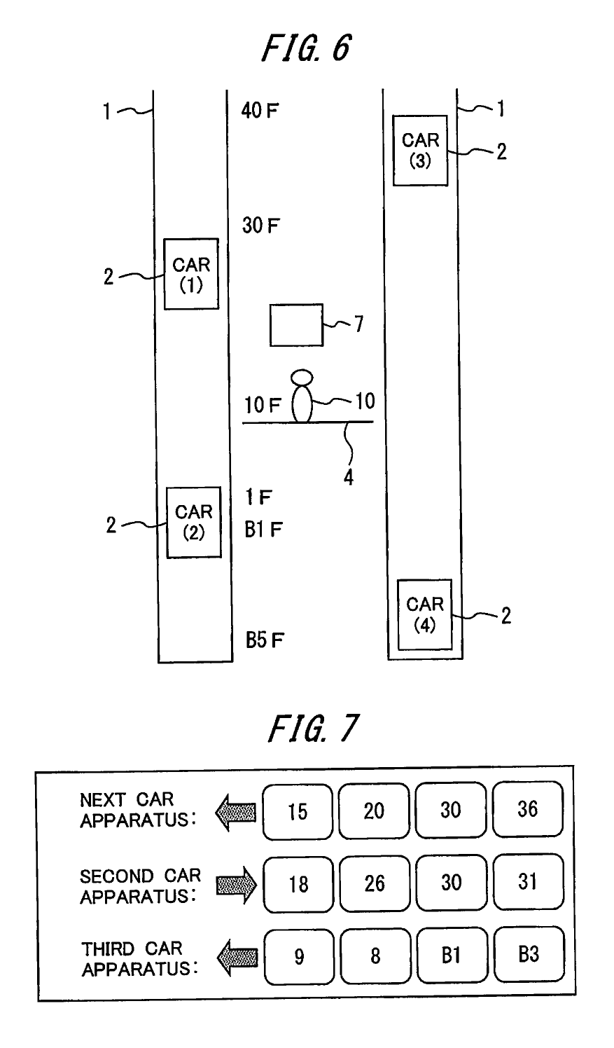

FIG. 6 is a block diagram of elevators in which an elevator display control device in Embodiment 2 of the present invention is used. Parts which are the same as in Embodiment 1 or corresponding parts bear identical numerals and descriptions of these parts are omitted.

The elevator of Embodiment 1 is a one-shaft multicar elevator. On the other hand, the elevator of Embodiment 2 comprises two one-shaft multicar elevators. Specifically, one shaft 1 is provided on one side of a hall 4. The other shaft 1 is provided on the other side of the hall 4.

In one shaft 1, two car apparatuses 2 are arranged in such a manner as to coincide with each other on a vertical projection plane. In the other shaft 1, two car apparatuses 2 are arranged in such a manner as to coincide with each other on a vertical projection plane.

A user 10 is present in the hall 4 of the 10-th floor. The user 10 registers a service floor from a hall operating panel 7. In this case, a group control system (not shown) assigns a hall call of the floor to be used in question and a car call of the service floor in question to one of the four car apparatuses 2. The group control system sends information corresponding to the floor to be used in question and the service floor in question to a display control device 9 (not shown in FIG. 6).

Next, the display part of the hall operating panel 7 will be described with the aid of FIG. 7.

FIG. 7 is a front view of the display part provided in the hall operating panel of elevators in which the elevator display control device in Embodiment 2 of the present invention is used.

As shown in FIG. 7, an arrow is displayed between “NEXT CAR APPARATUS” and a plurality of numerals. The arrow in question indicates the direction in which a shaft 1 in which a car apparatus 2 arriving at a floor to be used first is arranged is present. An arrow is displayed between “SECOND CAR APPARATUS” and a plurality of numerals. The arrow in question indicates the direction in which a shaft 1 in which the second car apparatus 2 arriving at a floor to be used is arranged is present. An arrow is displayed between “THIRD CAR APPARATUS” and a plurality of numerals. The arrow in question indicates the direction in which a shaft 1 in which the third car apparatus 2 arriving at a floor to be used is arranged is present.

In the case where the user 10 intends to go to the 30th floor, the user 10 recognizes that the car apparatus 2 arriving at the floor to be used first will go to the 30th floor. On this occasion, from the arrow between “NEXT CAR APPARATUS” and a plurality of numerals, the user 10 recognizes in which shaft 1 the car apparatus 2 in question is arranged

According to Embodiment 2 described above, the display part of the hall operating panel 7 performs display by correlating information indicating the direction in which the shaft 1 in which the car apparatus 2 in question is arranged is present with information indicating the order of arrival of car apparatuses 2. For this reason, even in the case where there are two shafts 1, it is possible to guide a user 10 to a car best suited to the movement of the user.

The display control device 9 may be applied to elevators in which a plurality of car apparatuses 2 are arranged in each of three or more shafts 1. Also in this case, it is possible to guide a user 10 to a car best suited to the movement of the user.

### INDUSTRIAL APPLICABILITY

As described above, the elevator display control device of the present invention can be applied to an elevator in which a user can be guided to a car best suited to the movement of the user.

### DESCRIPTION OF SYMBOLS

1 shaft, 2 car apparatus, 3 car operating panel, 4 hall, 5 hall door, 6 hall button, 7 hall operating panel, 8 control device, 9 display control device, 9a analysis part, 9b recording part, 9c storage part, 9d display control part, 10 user

1. An elevator display control device, comprising:
an analysis part analyzing service floors of a plurality of cars arranged in one shaft, and
a display control part causing a display part provided in a hall to display, on a basis of analysis results of the analysis part, information indicating the order of cars arriving at the hall by correlating the information with information indicating service floors of cars arriving in the order in question.

2. The elevator display control device according to claim 1, wherein the analysis part analyzes service floors of a plurality of cars provided in each of a plurality of shafts, and
wherein the display control part causes the display part provided in the hall to display information indicating the order of cars arriving at the hall in question by correlating the information with information indicating the direction in which a shaft in which cars arriving in the order in question are arranged is present.

3. The elevator display control device according to claim 1, wherein on the occasion when a service floor has been registered from an operating panel provided in the hall, the display control part causes the display part provided in the hall to display information indicating the order of cars arriving at the hall in question by correlating the information with information indicating service floors of cars arriving in the order in question.

4. The elevator display control device according to claim 1, wherein on the occasion when a hall call has been registered from a hall button provided in the hall, the display control part causes the display part provided in the hall to display information indicating the order of cars arriving at the hall in question by correlating the information with information indicating service floors of cars arriving in the order in question.

5. The elevator display control device according to claim 2, wherein on the occasion when a service floor has been registered from an operating panel provided in the hall, the display control part causes the display part provided in the hall to display information indicating the order of cars arriving at the hall in question by correlating the information with information indicating service floors of cars arriving in the order in question.

6. The elevator display control device according to claim 2, wherein on the occasion when a hall call has been registered from a hall button provided in the hall, the display control part causes the display part provided in the hall to display information indicating the order of cars arriving at the hall in question by correlating the information with information indicating service floors of cars arriving in the order in question.
